(19) United States
(12) Patent Application Publication
(10) Pub. No.: US 2013/0187838 A1
(43) Pub. Date: Jul. 25, 2013

(54) PLASMA DISPLAY PANEL AND REAR PLATE FOR PLASMA DISPLAY PANEL

(71) Applicants: Kenji Kiriyama, Hyogo (JP); Koichi Mizuno, Shiga (JP); Koichi Matsumoto, Osaka (JP); Masanori Suzuki, Osaka (JP)

(72) Inventors: Kenji Kiriyama, Hyogo (JP); Koichi Mizuno, Shiga (JP); Koichi Matsumoto, Osaka (JP); Masanori Suzuki, Osaka (JP)

(21) Appl. No.: 13/574,722

(22) PCT Filed: Jan. 24, 2012
(86) PCT No.: PCT/JP12/00408

§ 371 Date: Jul. 23, 2012

(51) Int. Cl. G09G 3/28

(52) U.S. Cl. 345/60

(57) ABSTRACT

A rear plate has a display region, and a non-display region provided around the display region. The rear plate further has a plurality of connection terminal parts, a plurality of middle connection wiring groups, a plurality of electrodes, an insulating layer, and a barrier rib. The plurality of connection terminal parts is provided in the non-display region so as to be spaced out each other. The plurality of middle connection wiring groups is provided in the non-display region so as to be spaced out each other. The middle connection wiring group includes a plurality of middle connection wirings. A dummy part is provided between the plurality of middle connection wiring groups. A lower layer of the barrier rib has the electrode and at least one part of the middle connection wiring group and at least one part of the dummy part.

### TECHNICAL FIELD

A technique disclosed herein relates to a plasma display panel used for a display device and the like and to a rear plate for a plasma display panel.

### BACKGROUND ART

A plasma display panel (hereinafter, referred to as a PDP) includes a front plate, and a rear plate provided so as to be opposed to the front plate. As a technique to form a barrier rib on the rear plate, a photolithography method is well known. More specifically, a photosensitive material is exposed to light through a photomask, whereby a desired shape is formed (refer to PTL 1, for example).

### CITATION LIST

### Patent Literature

PTL 1: Unexamined Japanese Patent Publication No. 2003-131580

### SUMMARY OF THE INVENTION

A PDP includes a front plate, and a rear plate provided so as to be opposed to the front plate. The rear plate has a display region to generate a discharge between the rear plate and the front plate, and a non-display region provided around the display region. The rear plate further has a plurality of connection terminal parts, a plurality of middle connection wiring groups, a plurality of electrodes, an insulating layer covering the middle connection wiring groups and the electrodes, and a barrier rib provided on the insulating layer. The plurality of electrodes is provided in the display region. The plurality of connection terminal parts is provided in the non-display region so as to be spaced out each other. The connection terminal part includes a plurality of connection terminals. The plurality of middle connection wiring groups is provided in the non-display region so as to be spaced out each other. The middle connection wiring group includes a plurality of middle connection wirings. One sides of the plurality of middle connection wirings are connected to the plurality of connection terminals. Other sides of the plurality of middle connection wirings are connected to the plurality of electrodes. A dummy part is provided between the plurality of middle connection wiring groups. A lower layer of the barrier rib has the electrode and at least one part of the middle connection wiring group and at least one part of the dummy part.

A rear plate for a PDP includes a display region to generate a discharge between the rear plate and a front plate, a non-display region provided around the display region, a plurality of connection terminal parts, a plurality of middle connection wiring groups, a plurality of electrodes, and an insulating layer covering the middle connection wiring groups and the electrodes. The plurality of electrodes is provided in the display region. The plurality of connection terminal parts is provided in the non-display region so as to be spaced to each other. The connection terminal part includes a plurality of connection terminals. The plurality of middle connection wiring groups is provided in the non-display region so as to be spaced to each other. The middle connection wiring group includes a plurality of middle connection wirings. One sides of the plurality of middle connection wirings are connected to the plurality of connection terminals. Other sides of the plurality of middle connection wirings are connected to the plurality of electrodes. A dummy part is provided between the plurality of middle connection wiring groups. A difference between a reflection rate of a region having the middle connection wiring group and a reflection rate of a region having the dummy part is smaller than a difference between the reflection rate of the region having the middle connection wiring group and a reflection rate of a region not having the dummy part.

### BRIEF DESCRIPTION OF DRAWINGS

FIG. 1 is an exploded perspective view showing a structure of a PDP according to a present exemplary embodiment.

FIG. 2 is an electrode arrangement diagram of the PDP according to the present exemplary embodiment.

FIG. 3 is a circuit block diagram of a plasma display device.

FIG. 4 is a diagram showing a drive voltage waveform to be applied to each electrode of the PDP.

FIG. 5 is a schematic cross-sectional view of the PDP according to the present exemplary embodiment.

FIG. 6 is a schematic plan view of a rear plate according to the present exemplary embodiment.

FIG. 7 is a view showing an electrode configuration of the rear plate according to the present exemplary embodiment.

FIG. 8 is a view showing an electrode configuration of a rear plate according to another exemplary embodiment.

FIG. 9 is a view showing a pattern of a first dummy electrode according to another exemplary embodiment.

FIG. 10 is a view showing a pattern of a second dummy electrode according to another exemplary embodiment.

### DESCRIPTION OF EMBODIMENTS

### First Exemplary Embodiment

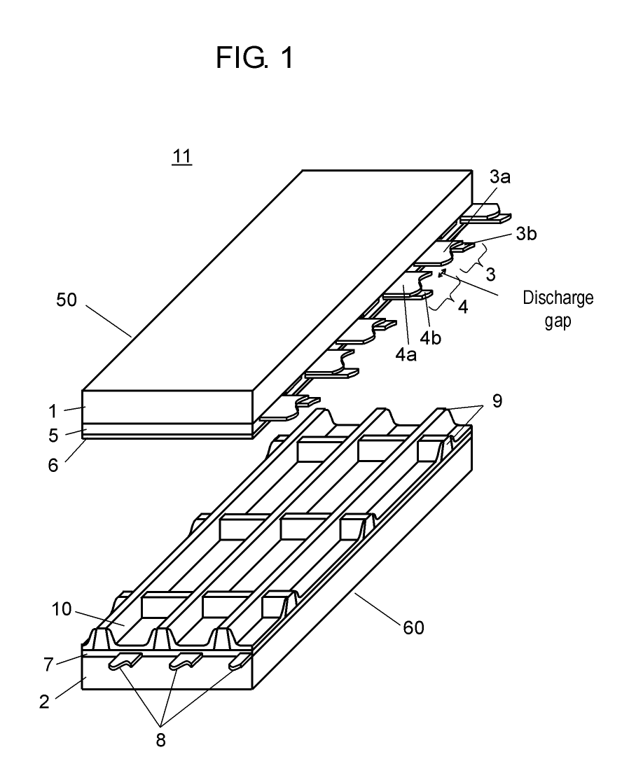

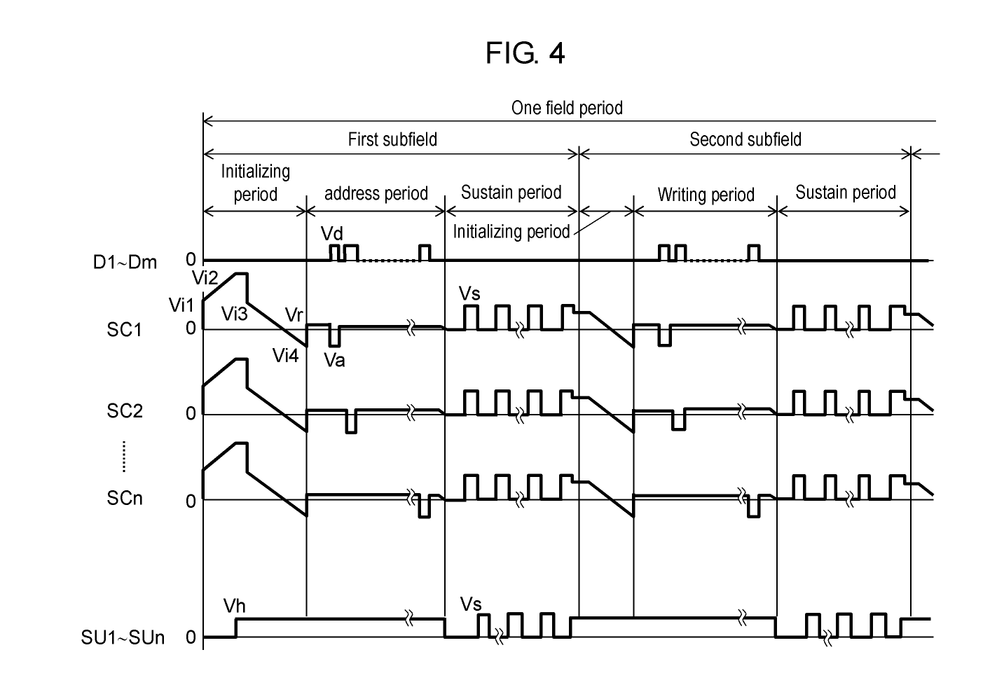

Hereinafter, a PDP according to one exemplary embodiment of the present invention will be described with reference to FIG. 1 through FIG. 7. However, an exemplary embodiment of the present invention is not limited to this.

### 1. CONFIGURATION OF PDP 11

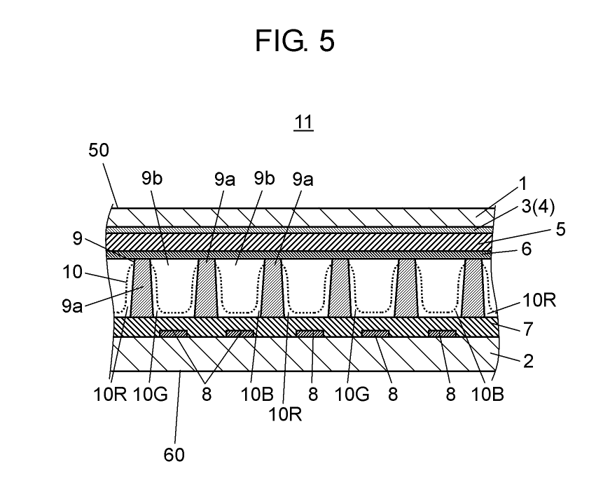

PDP 11 according to the present exemplary embodiment is an AC surface discharge type PDP. As shown in FIG. 1 and FIG. 5, PDP 11 is configured such that front plate 50 and rear plate 60 are arranged so as to be opposed to each other with a discharge space provided therebetween.

Front plate 50 has conductive scan electrode 3 and conductive sustain electrode 4 which are provided on front substrate 1 made of glass. Scan electrode 3 and sustain electrode 4 are covered with dielectric layer 5 made of a glass material and the like. Protective layer 6 containing a magnesium oxide (MgO) is provided on dielectric layer 5. Scan electrode 3 and sustain electrode 4 are arranged parallel to each other with a discharge gap provided therebetween. One pair of scan electrode 3 and sustain electrode 4 serves as a display electrode.

Scan electrode 3 includes transparent electrode 3a made of an indium tin oxide (ITO) and the like, and bus electrode 3b electrically connected to transparent electrode 3a. Bus electrode 3b contains a conductive metal such as silver (Ag). A film thickness of bus electrode 3b is about several micrometers.

Sustain electrode 4 includes transparent electrode 4a made of ITO and the like, and bus electrode 4b electrically connected to transparent electrode 4a. Bus electrode 4b contains a conductive metal such as Ag. A film thickness of bus electrode 4b is about several micrometers.

Rear plate 60 has conductive data electrode 8 provided on rear substrate 2 made of glass. Data electrode 8 is covered with insulating layer 7 made of a glass material. On insulating layer 7, curb-shaped barrier rib 9 made of a glass material and the like is provided to divide the discharge space between front plate 50 and rear plate 60 with respect to each discharge cell. In addition, rear plate 60 has phosphor layer 10.

As shown in FIG. 5, red phosphor layer 10R emitting red light, green phosphor layer 10G emitting green light, and blue phosphor layer 10B emitting blue light are provided on a surface of insulating layer 7 and on a side surface of barrier rib 9. Phosphor layer 10 is composed of red phosphor layer 10R, green phosphor layer 10G, and blue phosphor layer 10B. The discharge cell is provided in an intersecting part of scan electrode 3 and sustain electrode 4 with data electrode 8. In addition, a mixture gas of neon (Ne) and xenon (Xe) is enclosed in the discharge space as a discharge gas.

In addition, a structure of PDP 11 is not limited to the above, and it may be provided with striped barrier rib 9.

Furthermore, as shown in FIG. 5, curb-shaped barrier rib 9 to partition the discharge cell includes vertical barrier rib 9a provided parallel to data electrode 8, and horizontal barrier rib 9b provided so as to be orthogonal to vertical barrier rib 9a. In addition, blue phosphor layer 10B, red phosphor layer 10R, and green phosphor layer 10G are sequentially arranged into a stripe shape along vertical barrier rib 9a.

### 1-2. Electrode Arrangement of PDP 11

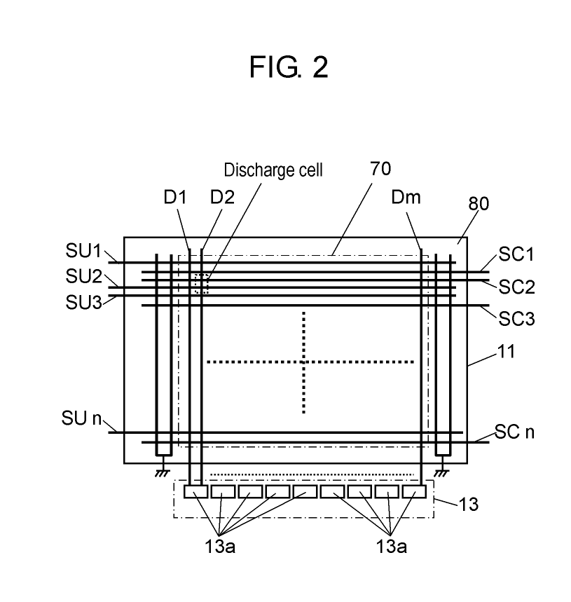

As shown in FIG. 2, in a display region of PDP 11, n scan electrodes SC1 to SCn (scan electrode 3 in FIG. 1) and n sustain electrodes SU1 to SUn (sustain electrode 4 in FIG. 1) are formed in a row direction so as to be arranged such that sustain electrode SU1, scan electrode SC1, scan electrode SC2, sustain electrode SU2 . . . , and m data electrodes D1 to Dm (data electrode 8 in FIG. 1) are formed in a column direction so as to be orthogonal to scan electrodes SC1 to SCn and n sustain electrodes SU1 to SUn. Thus, the discharge cell is formed in an intersection part of the pair of scan electrode SCi and sustain electrode SUi (i=1 to n) and one data electrode Dj (j=1 to m), and m×n discharge cells are formed in the discharge space. In addition, a non-display region is provided around a display region of PDP 11.

### 2. METHOD FOR PRODUCING PDP 11

### 2-1. Front Plate 50

### 2-1-1. Display Electrode

Scan electrode 3 and sustain electrode 4 are formed on front substrate 1 by a photolithography method. First, transparent electrodes 3a and 4a are formed of the indium tin oxide (ITO) and the like.

Then, bus electrodes 3b and 4b are formed. A material of bus electrodes 3b and 4b includes an electrode paste containing silver (Ag), a glass frit to bind the silver, a photosensitive resin, a solvent, and the like. First, the electrode paste is applied to front substrate 1 on which transparent electrodes 3a and 4a have been formed, by a screen printing method. Then, the electrode paste is dried, for example, at a temperature range of 100° C. to 250° C. in a baking oven. Through the drying process, the solvent in the electrode paste is removed. Then, the electrode paste is exposed to light through a photomask having a plurality of rectangular patterns, for example.

Then, the electrode paste is developed. When a positive type photosensitive resin is used, an exposed part is removed. The remaining electrode paste serves as an electrode pattern. Finally, the electrode pattern is fired, for example, at a temperature range of 400° C. to 550° C. in the baking oven. Through the firing process, the photosensitive resin in the electrode pattern is removed. Through the firing process, the glass frit in the electrode pattern is melted. The molten glass frit is vitrified again after fired. Through the above steps, bus electrodes 3b and 4b are formed.

Other than the above method, a metal film may be formed by a sputtering method, a vapor deposition method, and the like and then patterned.

### 2-1-2. Dielectric Layer 5

A material of dielectric layer 5 includes a dielectric paste containing a dielectric glass frit, a resin, a solvent, and the like. First, the dielectric paste is applied onto front substrate 1 so as to have a predetermined thickness by a die coating method. The applied dielectric paste covers scan electrode 3 and sustain electrode 4. Then, the dielectric paste is dried, for example, at a temperature range of 100° C. to 250° C. in the baking oven. Through the drying process, the solvent in the dielectric paste is removed. Finally, the dielectric paste is fired, for example, at a temperature range of 400° C. to 550° C. in the baking oven. Through the firing process, the resin in the dielectric paste is removed. Through the firing process, the dielectric glass frit is melted. The molten dielectric glass frit is vitrified again after fired. Through the above steps, dielectric layer 5 is formed.

Other than the above method, the screen printing, a spin coating method, and the like may be used. In addition, a film serving as dielectric layer 5 may be formed by a CVD (Chemical Vapor Deposition) method and the like without using the dielectric paste.

### 2-1-3. Protective Layer 6

Protective layer 6 is formed by an EB (Electron Beam) deposition device, as one example. In a case where protective layer 6 contains MgO and CaO, a material of protective layer 6 is an MgO pellet composed of a single crystal MgO and a CaO pellet composed of a single crystal CaO. That is, the pellet may be chosen according to a composition of protective layer 6. In addition, aluminum (Al), silicon (Si), or the like may be added to the MgO pellet or the CaO pellet, as impurities.

First, an electron beam is applied to the MgO pellet and the CaO pellet arranged in a film formation chamber of the EB deposition device. The MgO pellet and CaO pellet receive energy of the electron beam and their surfaces are evaporated. Thus, MgO evaporated from the MgO pellet and CaO evaporated from the CaO pellet are attached onto front substrate 1 moving in the film formation chamber. More specifically, MgO and CaO are attached on dielectric layer 5 with a mask having an opening which becomes the display region provided therebetween. Front substrate 1 has been heated to about 300° C. by a heater. As for a pressure in the film forming chamber, after it has been reduced to about 1 E-4 Pa, an oxygen gas is supplied, and an oxygen partial pressure is kept to be about 3 E-2 Pa. A film thickness of protective layer 6 is adjusted so as to fit in a predetermined range, according to an intensity of the electron beam, the pressure in the film formation chamber, and a moving speed of front substrate 1.

### 2-2. Rear Plate 60

### 2-2-1. Data Electrode 8

Data electrode 8 is formed on rear substrate 2 by the photolithography method. A material of data electrode 8 includes a data electrode paste containing silver (Ag) particles as a conductor, a glass frit to bind the silver particles, a photosensitive resin, a solvent, and the like.

First, the data electrode paste is applied onto rear substrate 2 so as to have a predetermined thickness, by the screen printing method. Then, the data electrode paste is dried, for example, at a temperature range of 100° C. to 250° C. in the baking oven. Through the drying process, the solvent in the data electrode paste is removed. Then, the data electrode paste is exposed to light through a photomask on which a plurality of rectangular patterns is formed, for example. Then, the data electrode paste is developed. When the positive type photosensitive resin is used, an exposed part is removed. The remaining data electrode paste serves as a data electrode pattern. Finally, the data electrode pattern is fired, for example, at a temperature range of 400° C. to 550° C. in the baking oven. Through the firing process, the photosensitive resin in the data electrode pattern is removed. Through the firing process, the glass frit in the data electrode pattern is melted. The molten glass frit is vitrified again after fired. Through the above steps, data electrode 8 is formed.

Other than the above method, a metal film may be formed by the sputtering method, or the vapor deposition method, and then patterned.

### 2-2-2. Insulating Layer 7

A material of insulating layer 7 includes an insulating paste containing a glass frit, a filler, a resin, a solvent, and the like. A ratio of the glass frit to a sum of the glass frit and the filler is between 15% by weight to 45% by weight.

First, the insulating paste is applied onto rear substrate 2, by the screen printing method or the like so as to have a predetermined thickness. The applied insulating paste covers data electrode 8. Then, the insulating paste is dried, for example, at a temperature range of 100° C. to 250° C. in the baking oven. Through the drying process, the solvent in the insulating paste is removed. Finally, the insulating paste is fired, for example, at a temperature range of 400° C. to 550° C. in the baking oven. Through the firing process, the resin in the insulating paste is removed. In addition, through the firing process, the glass frit is melted. Meanwhile, the filler is not melted by the firing process. The molten glass frit is vitrified again after fired. That is, insulating layer 7 has a configuration in which the filler is dispersed in the glass component. Through the above steps, insulating layer 7 is formed. Other than the screen printing method, the spin coating method, die coating method, and the like may be used.

### 2-2-3. Barrier Rib 9

Barrier rib 9 is formed by the photolithography method. A material of barrier rib 9 includes a barrier rib paste containing a filler, a glass frit to bind the filler, a photosensitive resin, a solvent, and the like. A ratio of the glass frit to a sum of the glass frit and the filler is between 60% by weight to 90% by weight.

First, the barrier rib paste is applied onto insulating layer 7 by the die coating method and the like so as to have a predetermined thickness. Then, the barrier rib paste is dried, for example, at a temperature range of 100° C. to 250° C. in the baking oven. Through the drying process, the solvent in the barrier rib paste is removed. Then, the barrier rib paste is exposed to light through a photomask having a curb-shaped pattern, for example. Then, the barrier rib paste is developed. When the positive type photosensitive resin is used, an exposed part is removed. The remaining barrier rib paste serves as a barrier rib pattern. Finally, the barrier rib pattern is fired, for example, at a temperature range of 500° C. to 600° C. in the baking oven. Through the firing process, the photosensitive resin in the barrier rib pattern is removed. Through the firing process, the glass frit in the barrier rib pattern is melted. Meanwhile, the filler is not melted by the firing process. The molten glass frit is vitrified again after fired. That is, barrier rib 9 has a configuration in which the filler is dispersed in the glass component. Through the above steps, barrier rib 9 is formed.

### 2-2-4. Phosphor Layer

A material of the phosphor layer includes a phosphor paste containing phosphor particles, a binder, a solvent, and the like.

First, the phosphor paste is applied by a dispensing method and the like onto insulating layer 7 provided between adjacent barrier ribs 9 and the side surface of barrier rib 9 so as to have a predetermined thickness. Then, the solvent in the phosphor paste is removed in the baking oven. Finally, the phosphor paste is fired at a predetermined temperature in the baking oven. That is, the resin in the phosphor paste is removed. Through the above steps, red phosphor layer 10R emitting the red light, green phosphor layer 10G emitting the green light, and blue phosphor layer 10B emitting the blue light are formed. Other than the dispensing method, the screen printing method and the like may be used.

Through the above steps, rear plate 60 is completed such that the predetermined components are formed on rear substrate 2.

### 2-3. Method for Assembling Front Plate 50 and Rear Plate 60

First, a sealing material (not shown) is applied to a circumference of rear plate 60 by the dispensing method. The sealing material (not shown) includes a sealing paste containing a glass frit, a binder, a solvent, and the like. Then, the solvent in the sealing paste is removed in the baking oven. Then, front plate 50 and rear plate 60 are oppositely arranged such that scan electrode 3 and sustain electrode 4 intersect with data electrode 8. Then, the circumferences of front plate 50 and rear plate 60 are sealed by the glass frit. Finally, the discharge gas containing Ne, Xe, and the like is enclosed in the discharge space. As described above, front plate 50 and rear plate 60 are assembled, whereby PDP 11 is completed.

### 3. CIRCUIT BLOCK OF PLASMA DISPLAY DEVICE 100

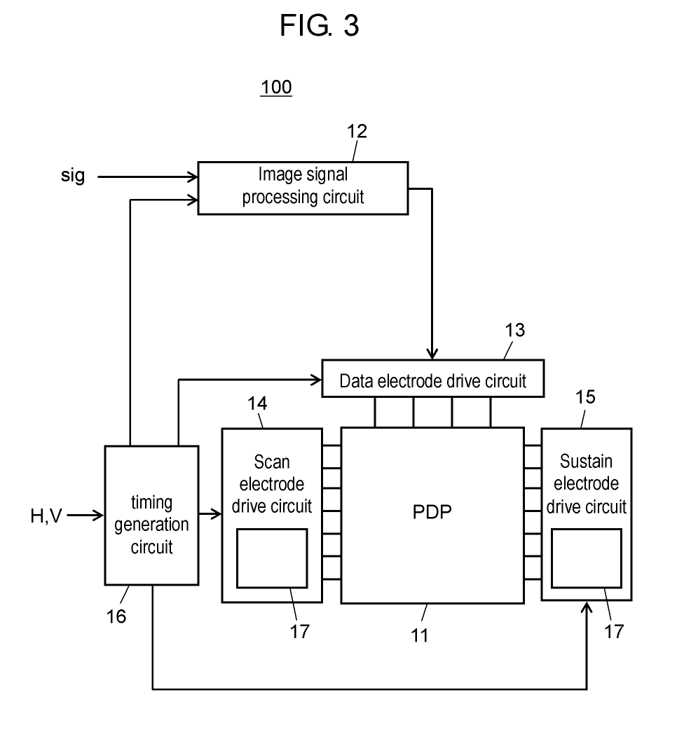

As shown in FIG. 3, plasma display device 100 includes PDP 11, image signal processing circuit 12, data electrode drive circuit 13, scan electrode drive circuit 14, sustain electrode drive circuit 15, timing generation circuit 16, and a power supply circuit (not shown).

In addition, as shown in FIG. 2, data electrode drive circuit 13 is connected to one end of data electrode 8. Furthermore, data electrode drive circuit 13 has a plurality of data drivers 13a each composed of a semiconductor element to supply a voltage to data electrode 8. A plurality of data electrodes 8 constitutes one data electrode block. PDP 11 has the plurality of data electrode blocks. As one example, one data driver 13a supplies a voltage to one data electrode block.

In FIG. 3, image signal processing circuit 12 converts image signal sig to image data with respect to each sub-field. Data electrode drive circuit 13 converts the image data of each sub-field to a signal corresponding to each of data electrodes D1 to Dm, and drives each of data electrodes D1 to Dm. Timing generation circuit 16 generates various kinds of timing signals based on horizontal synchronizing signal H and vertical synchronizing signal V, and supplies the various kinds of timing signals to each drive circuit block. Scan electrode drive circuit 14 supplies a drive voltage waveform to scan electrodes SC1 to SCn based on the timing signal, and sustain electrode drive circuit 15 supplies a drive voltage waveform to sustain electrodes SU1 to SUn based on the timing signal. Each of scan electrode drive circuit 14 and sustain electrode drive circuit 15 has sustain pulse generation part 17.

### 3-1. Drive Voltage Waveform and Driving Operation

According to PDP 11 in the present exemplary embodiment, the one field is divided into a plurality of sub-fields, and each sub-field has an initializing period, an address period, and a sustain period.

### 3-1-1. Initializing Period

In the initializing period of the first sub-field, data electrodes D1 to Dm and sustain electrodes SU1 to SUn are held at 0 (V), and a ramp voltage which gradually rises from voltage Vil (V) which is below a discharge start voltage to voltage Vi2 (V) which is above the discharge start voltage is applied to scan electrodes SC1 to SCn. Then, a first weak initializing discharge is generated in all of the discharge cells, and a negative wall voltage is stored on scan electrodes SC1 to SCn, and a positive wall voltage is stored on sustain electrodes SU1 to SUn and data electrodes D1 to Dm. Here, the wall voltage on the electrode means a voltage generated by wall charges accumulated on dielectric layer 5 and the phosphor layer which cover the electrodes. After that, sustain electrodes SU1 to SUn are held at positive voltage Vh (V), and a ramp voltage which gradually falls from voltage Vi3 (V) to voltage Vi4 (V) is applied to scan electrodes SC1 to SCn. Then, a second weak initializing discharge is generated in all of the discharge cells, and the wall voltage between scan electrodes SC1 to SCn and sustain electrodes SU1 to SUn is weakened and the wall voltage on data electrodes D1 to Dm is also adjusted to a value suitable for an address operation.

### 3-1-2. Address Period

In a following address period, scan electrodes SC1 to SCn are held at Vr (V) once. Then, negative scan pulse voltage Va (V) is applied to scan electrode SC1 in a first row, and positive address pulse voltage Vd (V) is applied to data electrode Dk (k=1 to m) of the discharge cell to be displayed in the first row among data electrodes D1 to Dm. At this time, a voltage at an intersection part between data electrode Dk and scan electrode SC1 is given by adding the wall voltage on data electrode Dk and the wall voltage on scan electrode SC1 to an externally applied voltage (Vd-Va) (V), and this voltage exceeds the discharge start voltage. Thus, an address discharge is generated between data electrode Dk and scan electrode SC1 and between sustain electrode SU1 and scan electrode SC1. Then, the positive wall voltage is stored on scan electrode SC1 of this discharge cell, the negative wall voltage is stored on sustain electrode SU1, and the negative wall voltage is also stored on data electrode Dk.

Thus, the address discharge is generated in the discharge cell to be displayed in the first row, and the address operation in which the wall voltage is stored on each electrode is performed. Meanwhile, since the voltage at the intersection parts of data electrodes D1 to Dm to which address pulse voltage Vd (V) is not applied and scan electrode SC1 does not exceed the discharge start voltage, the address discharge is not generated. The above address operation is sequentially performed until the discharge cell in the n-th row, and the address period is completed.

### 3-1-3. Sustain Period

In a following sustain period, positive sustain pulse voltage Vs (V) is applied to scan electrodes SC1 to SCn as a first voltage, and a ground potential, that is, 0 (V) is applied to sustain electrodes SU1 to SUn as a second voltage. At this time, as for the discharge cell in which the address discharge has been generated, the voltage applied between scan electrode SCi (i=1 to n) and sustain electrode SUi is given by adding the wall voltage on scan electrode SCi and the wall voltage on sustain electrode SUi to sustain pulse voltage Vs (V), and this voltage exceeds the discharge start voltage. Thus, the sustain discharge is generated between scan electrode SCi and sustain electrode SUi, and ultraviolet light generated at this time allows the phosphor layer 10 to emit light. Thus, the negative wall voltage is stored on scan electrode SCi, and the positive wall voltage is stored on sustain electrode SUi. At this time, the positive wall voltage is also stored on data electrode Dk. As for the discharge cell in which the address discharge has not been generated in the address period, the sustain discharge is not generated, and the wall voltage at the time of the end of the initializing period is held. Then, the second voltage of 0 (V) is applied to scan electrodes SC1 to SCn, and the first voltage of sustain pulse voltage Vs (V) is applied to sustain electrodes SU1 to SUn. Then, as for the discharge cell in which the sustain discharge has been generated, since the voltage between sustain electrode SUi and scan electrode SCi exceeds the discharge start voltage, the sustain discharge is generated between sustain electrode SUi and scan electrode SCi again, so that the negative wall voltage is stored on sustain electrode SUi, and the positive wall voltage is stored on scan electrode SCi.

### 3-1-4. Following Second Sub-Field

Similarly, the sustain pulse whose number corresponds to a luminance weight is applied to scan electrodes SC1 to SCn and sustain electrodes SU1 to SUn alternately, so that the sustain discharge is continuously generated in the discharge cell in which the address discharge has been generated in the address period. Thus, the sustain operation in the sustain period is completed. Since operations in the initializing period, the address period, and the sustain period in the following sub-field are roughly the same as those in the first sub-field, a description therefore is omitted.

### 4. DETAIL OF REAR PLATE 60

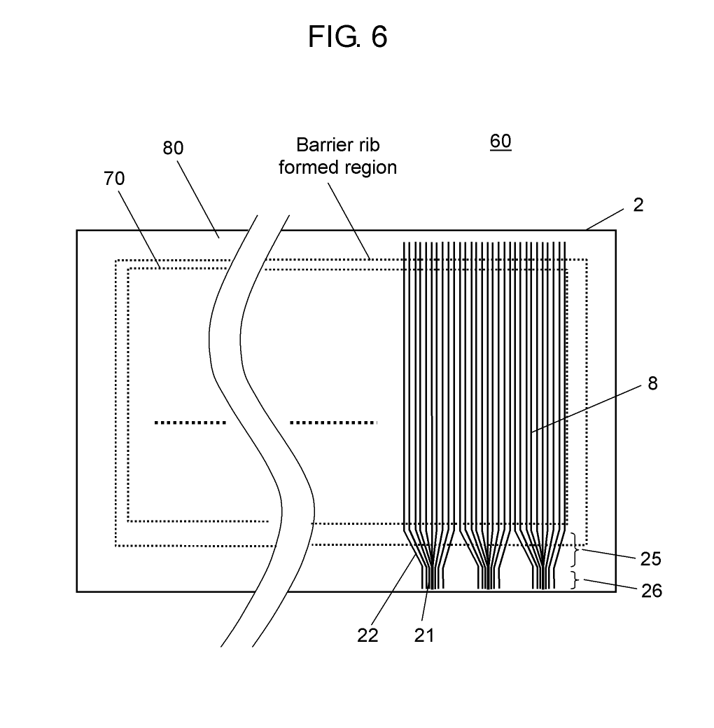

As shown in FIG. 6, rear plate 60 has display region 70 and non-display region 80 provided around display region 70. A barrier rib formed region is larger than display region 70. A plurality of connection terminals 21 to connect data electrodes 8 to data electrode drive circuit 13 are provided at an end of a long side of rear substrate 2. The plurality of connection terminals 21 are arranged at predetermined pitches in the column direction. The plurality of connection terminals 21 constitutes one connection terminal part 26. A plurality of connection terminal parts 26 are provided on rear substrate 2. The number of connection terminals 21 included in one connection terminal part 26 is designed according to the number of wirings such as a flexible printed substrate used for connection to data electrode drive circuit 13.

Connection terminal 21 is connected to data electrode 8 through middle connection wiring 22. That is, one sides of a plurality of middle connection wirings 22 are connected to the plurality of connection terminals 21. Other sides of the plurality of middle connection wirings 22 are connected to the plurality of data electrodes 8. The plurality of middle connection wirings 22 constitutes one middle connection wiring group 25. The plurality of middle connection wiring groups 25 and the plurality of connection terminal parts 26 are provided in non-display region 80.

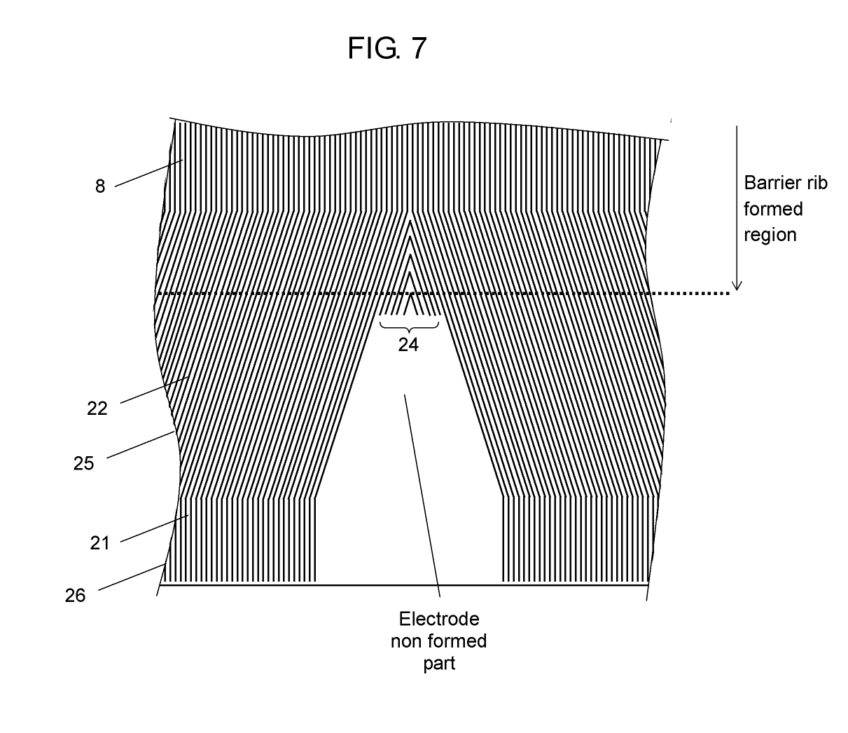

As shown in FIG. 6 and FIG. 7, middle connection wirings 22 are gathered such that their pitches become narrow from data electrode 8 toward connection terminal 21. This is based on reasons such as a layout of a circuit substrate. A space between middle connection wiring group 25 and middle connection wiring group 25 is an electrode non-formed part in which middle connection wiring 22 and data electrode 8 are not formed.

According to the present exemplary embodiment, dummy electrode 24 is provided in a barrier rib formed region of the electrode non-formed part. The drive voltage is not applied to dummy electrode 24. Various configurations are applicable for dummy electrode 24. In addition, dummy electrode 24 may be used for confirming a process margin.

Incidentally, when barrier rib 9 is formed by the photolithography method, light emitted from an exposure lamp is reflected by surfaces of insulating layer 7, data electrode 8, and rear substrate 2. The reflected light affects a shape of barrier rib 9. That is, in a case where the barrier rib formed region reaches the region of middle connection wiring 22 of data electrode 8, the electrode non-formed part between middle connection wiring group 25 and middle connection wiring group 25 is provided on insulating layer 7 on rear substrate 2. Therefore, a reflection rate of the light generated from the exposure lamp (hereinafter, referred to as the reflection rate) which is used for forming barrier rib 9 in the electrode non-formed part is different from that in the region having middle connection wiring group 25. In addition, when the reflection rates are different, barrier rib 9 could partially become high at an end part of barrier rib 9. That is, the height of barrier rib 9 is not uniform, which causes a problem such as crosstalk that a display quality is damaged.

However, according to the present exemplary embodiment, a difference between a reflection rate of the region having dummy electrode 24 and the reflection rate of the region having middle connection wiring group 25 is smaller than a difference in reflection rate between the electrode non-formed region having no dummy electrode 24 and the region having middle connection wiring group 25. Therefore, the problem that barrier rib 9 partially becomes high at the end part of barrier rib 9 can be prevented from being generated. As a result, the crosstalk and the like are prevented from being generated. That is, deterioration in display quality can be improved.

In addition, dummy electrode 24 only has to overlap with the barrier rib formed region in at least one part thereof. In addition, dummy electrode 24 may protrude from the barrier rib formed region toward connection terminal 21. In addition, dummy electrode 24 may protrude from the barrier rib formed region toward the display region. Furthermore, dummy electrode 24 is preferably made of the same material as that of middle connection wiring 22. This is because the reflection rate is equal to each other.

According to the present exemplary embodiment, data electrode 8, middle connection wiring 22, and dummy electrode 24 are made of the same material, as one example. The inventors have measured the reflection rate and found that the reflection rate of the region not having dummy electrode 24 is higher than that of the region having dummy electrode 24 by 10%. The reflection rate of the region not having middle connection wiring group 25 is higher than that of the region having middle connection wiring group 25 by 10%. That is, the difference between the reflection rate of the region having middle connection wiring group 25 and the reflection rate of the region having dummy electrode 24 is smaller than the difference between the reflection rate of the region having middle connection wiring group 25 and the reflection rate of the region not having dummy electrode 24. In addition, a spectrophotometer (type: CM-2600) made by Konica Minolta Holdings, Inc. is used to measure the reflection rate. A wavelength used for the measurement is 360 nm.

Furthermore, in the present exemplary embodiment, an ultraviolet lamp is used to expose the barrier rib paste. The ultraviolet lamp is not particularly specified. That is, any lamp can be used as long as it generates a wavelength of an ultraviolet light range. For example, it includes a low-pressure mercury lamp, a high-pressure mercury lamp, an ultra-high pressure mercury lamp, a halogen lamp, a germicidal lamp, and the like. Among them, the ultra-high pressure mercury lamp is preferable. In the present exemplary embodiment, i line (light having a wavelength of 365 nm) is used.

In addition, in the present exemplary embodiment, a film thickness of barrier rib paste at the time of the exposure is between 180 μm to 190 μm. Furthermore, a film thickness of insulating layer 7 at the time of exposure is 20 μm.

### 5. CONCLUSION

PDP 11 disclosed in the present exemplary embodiment includes front plate 50, and rear plate 60 provided so as to be opposed to front plate 50. Rear plate 60 has display region 70 to generate the discharge between rear plate 60 and front plate 50, and non-display region 80 provided around display region 70. Furthermore, rear plate 60 has the plurality of connection terminal parts 26, the plurality of middle connection wiring groups 25, the plurality of data electrodes 8, insulating layer 7 which covers middle connection wiring groups 25 and data electrodes 8, and barrier rib 9 provided on insulating layer 7. The plurality of data electrodes 8 are provided in display region 70. The plurality of connection terminal parts 26 are provided in non-display region 80 so as to be spaced to each other. Connection terminal part 26 includes the plurality of connection terminals 21. The plurality of middle connection wiring groups 25 are provided in non-display region 80 so as to be spaced to each other. Middle connection wiring group 25 includes the plurality of middle connection wirings 22. The one sides of the plurality of middle connection wirings 22 are connected to the plurality of connection terminals 21. The other sides of the plurality of middle connection wiring 22 are connected to the plurality of data electrodes 8. Dummy electrode 24 serving as the dummy part is provided between the plurality of middle connection wiring groups 25. A lower layer of barrier rib 9 has at least one part of data electrode 8 and middle connection wiring group 25 and at least one part of dummy electrode 24.

According to the above configuration, the problem that barrier rib 9 partially becomes high at the end part of barrier rib 9 can be prevented from being generated. As a result, the crosstalk and the like can be prevented from being generated. That is, the deterioration in display quality can be improved.

Rear plate 60 disclosed in the present exemplary embodiment includes display region 70 to generate the discharge between rear plate 60 and front plate 50, non-display region 80 provided around display region 70, the plurality of connection terminal parts 26, the plurality of middle connection wiring groups 25, the plurality of data electrodes 8, and insulating layer 7 which cover middle connection wiring groups 25 and data electrodes 8. The plurality of data electrodes 8 are provided in display region 70. The plurality of connection terminal parts 26 are provided in non-display region 80 so as to be spaced to each other. Connection terminal part 26 includes the plurality of connection terminals 21. The plurality of middle connection wiring groups 25 are provided in non-display region 80 so as to be spaced to each other. Middle connection wiring group 25 includes the plurality of middle connection wirings 22. The one sides of the plurality of middle connection wirings 22 are connected to the plurality of connection terminals 21. The other sides of the plurality of middle connection wiring 22 are connected to the plurality of data electrodes 8. Dummy electrode 24 serving as the dummy part is provided between the plurality of middle connection wiring groups 25. The difference between the reflection rate of the region having middle connection wiring group 25 and the reflection rate of the region having dummy electrode 24 is smaller than the difference between the reflection rate of the region having middle connection wiring group 25 and the reflection rate of the region not having dummy electrode 24.

According to the above configuration, the reflection rate is prevented from being varied in the lower layer of barrier rib paste at the time of the exposure of the barrier rib paste. Thus, the problem that barrier rib 9 partially becomes high at the end part of barrier rib 9 can be prevented from being generated. As a result, the crosstalk and the like are prevented from being generated. That is, the deterioration in display quality can be improved.

### Other Exemplary Embodiments

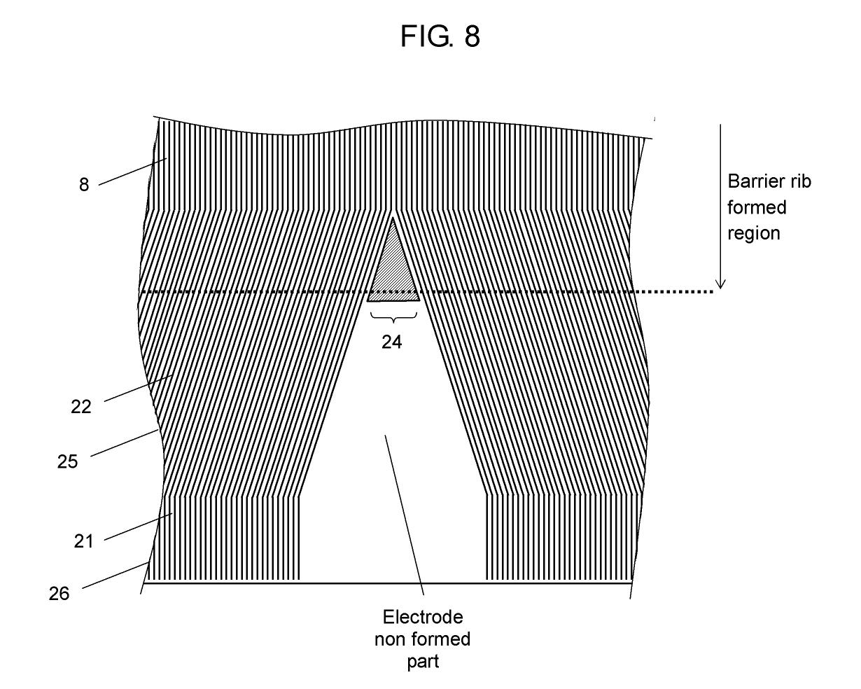

In addition, the present invention is not limited to the first exemplary embodiment. For example, when a density of dummy electrode 24 is equal to a density of middle connection wiring 22, the same effect as that of the first exemplary embodiment can be obtained. As shown in FIG. 8, the pitch of dummy electrode 24 may be narrowed and dummy electrode 24 may be formed into a fill pattern.

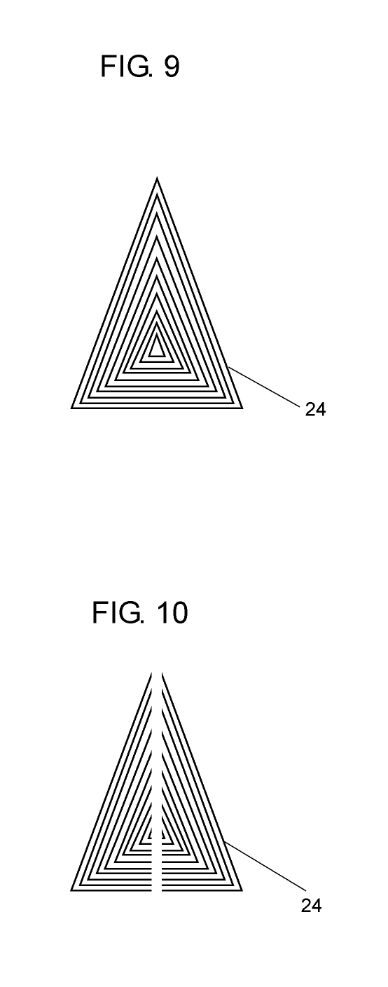

Furthermore, as shown in FIG. 9, dummy electrode 24 may be formed into a pattern in which triangles are provided in a multiple manner. Furthermore, as shown in FIG. 10, dummy electrode 24 may be formed into a pattern in which triangles whose one ends are cut are provided in a multiple manner. In addition, a tip end part of dummy electrode 24 may have a round shape.

Furthermore, instead of providing dummy electrode 24, the material of insulating layer 7 may be varied appropriately to reduce the difference in reflection rate.

### INDUSTRIAL APPLICABILITY

The technique disclosed herein can improve a quality of the PDP, so that it can be useful for a display device having a large screen and the like.

### REFERENCE MARKS IN THE DRAWINGS

1 front plate
2 rear plate
3 scan electrode
4 sustain electrode
3a, 4a transparent electrode
3b, 4b bus electrode
5 dielectric layer
6 protective layer
7 insulating layer
8 data electrode
9 barrier rib
9a vertical barrier rib
9b horizontal barrier rib
10R red phosphor layer
10G green phosphor layer
10B blue phosphor layer
11 PDP
12 image signal processing circuit
13 data electrode drive circuit
13a data driver
14 scan electrode drive circuit
15 sustain electrode drive circuit
16 timing generation circuit
17 sustain pulse generation part
21 connection terminal
22 middle connection wiring
24 dummy electrode
25 middle connection wiring group
26 connection terminal part
50 front plate
60 rear plate
70 display region
80 non-display region
100 plasma display device

1-2. (canceled)

3. A rear plate for a plasma display panel having a display region to generate a discharge between the rear plate and a front plate, and a non-display region provided around the display region, wherein
the rear plate comprises a plurality of connection terminal parts, a plurality of middle connection wiring groups, a plurality of electrodes, a dummy part, and a barrier rib,
the display region has the plurality of electrodes,
the non-display region has the plurality of connection terminal parts, the plurality of middle connection wiring groups, and the plurality of dummy parts,
one sides of the plurality of middle connection wiring groups are connected to the plurality of connection terminal parts,
other sides of the plurality of middle connection wiring groups are connected to the plurality of electrodes,
a region having the dummy part, and a region not having the dummy part are provided between the plurality of middle connection wiring groups,
the barrier rib is provided in the display region and the non-display region,
a lower layer of the barrier rib is disposed to the plurality of electrodes, at least one part of the plurality of middle connection wiring groups, and the dummy part, and
in the non-display region, a difference between a reflection rate of a region having the middle connection wiring group and a reflection rate of the region having the dummy part is smaller than a difference between the reflection rate of the region having the middle connection wiring group and a reflection rate of the region not having the dummy part.

4. The rear plate for a plasma display panel according to claim 3, wherein
the dummy part and the middle connection wiring group are made of substantially the same material.

5. The rear plate for a plasma display panel according to claim 3, wherein
the reflection rate of the region having the middle connection wiring group and the reflection rate of the region having the dummy part are reflection rates of light having a wavelength of 360 nm.

6. The rear plate for a plasma display panel according to claim 4, wherein
a wiring density of the dummy part and a wiring density of the middle connection wiring group are substantially equal to each other.

7. A plasma display panel comprising the rear plate according to claim 3.

8. A plasma display panel comprising the rear plate according to claim 4.

9. A plasma display panel comprising the rear plate according to claim 5.

10. A plasma display panel comprising the rear plate according to claim 6.
